(19) United States
(12) Patent Application Publication
(10) Pub. No.: US 2026/0203258 A1
(43) Pub. Date: Jul. 16, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Kawasaki-shi (JP)

(72) Inventors: Nao MISHIMA, Inagi (JP); Yuishi TAKENO, Numazu (JP); Satoshi ITO, Kawasaki (JP); Tomoyuki SHIBATA, Kawasaki (JP)

(73) Assignee: KABUSHIKI KAISHA TOSHIBA, Kawasaki-shi (JP)

(21) Appl. No.: 19/442,127

(22) Filed: Jan. 7, 2026

(30) Foreign Application Priority Data
Jan. 15, 2025 (JP) 2025-005271

(51) Int. Cl. G06F 16/21; G06F 16/51; G06F 16/56; G06V 10/74; G06V 10/75; G06V 20/40

(52) U.S. Cl. CPC G06F 16/212; G06F 16/51; G06F 16/56; G06V 10/751; G06V 10/761; G06V 20/41

(57) ABSTRACT

In an information processing device, a collation unit collates a target in a frame for each frame in a moving-image, and adds identification-information for identifying a collation-result in the frame to an identification-information-sequence. The acquisition unit acquires the voting-target-sequence from the identification-information-sequence in the newness order of an addition time of the identification-information. The voting unit votes on the collation-result using the identification-information in the voting-target-sequence. The determiner determines whether to confirm the voting data, decides to extend the length of the voting-target-sequence when the voting data is not confirmed, and outputs a collation-result based on the voting data when the voting data is confirmed. The acquisition unit extends a length of the voting-target-sequence according to the determiner's decision. When the length of the voting-target-sequence is extended, the voting unit continues voting on the collation-result using the identification-information in the extended voting-target-sequence.

### CROSS-REFERENCE TO RELATED APPLICATIONS

This application is based upon and claims the benefit of priority from Japanese Patent Application No. 2025-005271, filed on Jan. 15, 2025; the entire contents of which are incorporated herein by reference.

### FIELD

Embodiments described herein relate generally to an information processing device, an information processing method, and a computer program product.

### BACKGROUND

As a method of improving the accuracy of collation of a person included in a moving image, best shot selection has been conventionally known. In collating a person, collation accuracy is improved when the person is entirely well-captured rather than when the face or the body is partially uncaptured; however, collation accuracy lowers even when the person is entirely captured if the person is far away and is captured as too small. In order to perform collation, it is desirable that the person is framed at a proper angle of view. The best shot selection is a method in which such a condition of an appropriate angle of view is defined in advance, and an image satisfying the condition is used as the best shot for collation.

However, in the related art, it is difficult to further shorten the processing time until the collation of the object is confirmed without lowering the collation accuracy.

### BRIEF DESCRIPTION OF THE DRAWINGS

FIG. 1 is a diagram illustrating an example of a functional configuration of an information processing device according to the first embodiment;

FIG. 2 is a diagram illustrating an example of a collation process by a collation unit according to the first embodiment;

FIG. 3 is a diagram for explaining a flow of an information processing method according to the first embodiment;

FIG. 4 is a diagram for explaining an example of the confirmation determination of a voting result by extension of an ID sequence according to the first embodiment;

FIG. 5 is a diagram illustrating a voting and confirmation determination processing example according to the first embodiment;

FIG. 6 is a flowchart illustrating an overall flow of an information processing method according to the first embodiment;

FIG. 7 is a flowchart illustrating an example of a voting method according to the first embodiment;

FIG. 8 is a flowchart illustrating an example of the determination process according to the first embodiment;

FIG. 9 is a diagram illustrating a relationship between the number of votes and collation accuracy according to the first embodiment;

FIG. 10A is a diagram for explaining stabilization of the voting confirmation process according to the first embodiment;

FIG. 10B is a diagram for explaining stabilization of the voting confirmation process according to the first embodiment;

FIG. 11 is a diagram illustrating a voting and confirmation determination processing example according to the first modification of the first embodiment;

FIG. 12 is a diagram illustrating a voting and confirmation determination processing example according to the second modification of the first embodiment;

FIG. 13 is a flowchart illustrating an example of the determination process according to the second modification of the first embodiment;

FIG. 14 is a diagram illustrating an example of a functional configuration of an information processing device according to the second embodiment;

FIG. 15 is a diagram illustrating an example of a functional configuration of an information processing device according to the third embodiment;

FIG. 16 is a diagram illustrating an example of a functional configuration of an information processing device according to the fourth embodiment;

FIG. 17 is a diagram illustrating an example of a functional configuration of an information processing device according to the fifth embodiment;

FIG. 18 is a diagram illustrating an example of a functional configuration of an information processing device according to the sixth embodiment;

FIG. 19 is a diagram illustrating an example of a functional configuration of an information processing device according to the seventh embodiment;

FIG. 20 is a diagram for explaining a flow of an information processing method according to the seventh embodiment;

FIG. 21 is a flowchart illustrating an example of object detection and tracking processing according to the seventh embodiment;

FIG. 22 is a diagram illustrating an example of a functional configuration of an information processing device according to the eighth embodiment;

FIG. 23 is a diagram illustrating an example of division processing by a divider according to the eighth embodiment;

FIG. 24 is a diagram illustrating an example of a functional configuration of an information processing device according to the ninth embodiment; and

FIG. 25 is a diagram illustrating an example of a hardware configuration of an information processing device according to the first to ninth embodiments.

### DETAILED DESCRIPTION

According to an embodiment, an information processing device includes one or more hardware processors configured to function as a collation unit, an acquisition unit, a voting unit, a determiner. The a collation unit is configured to collate a target included in a frame for each frame included in a moving image, and add identification information for identifying a collation result in the frame to an identification information sequence. The acquisition unit is configured to acquire voting target sequences indicating identification information sequences to be voted from the identification information sequence in an order of newness of an addition time of the identification information. The voting unit is configured to obtain voting data by voting on a collation result using identification information included in the voting target sequence. The determiner is configured to determine whether to confirm the voting data, decide to extend a length of the voting target sequence in a case where the voting data is not confirmed, and output a collation result based on the voting data in a case where the voting data is confirmed. The acquisition unit extends a length of the voting target sequence according to a decision by the determiner. In a case where the length of the voting target sequence is extended, the voting unit continues voting on the collation result using identification information included in the extended voting target sequence.

Hereinafter, embodiments of an information processing device, an information processing method, and a computer program product will be described in detail with reference to the accompanying drawings. The present disclosure is not limited to the following embodiments.

### First Embodiment

In the first embodiment, a case of collating an object ID (an example of identification information, for example, ID1, ID2, ID3, ID4, ID5, ID6, ID7 . . . ) for identifying an object from the object appearing in a video captured by a camera, a video camera, or the like will be described.

### Example of Functional Configuration

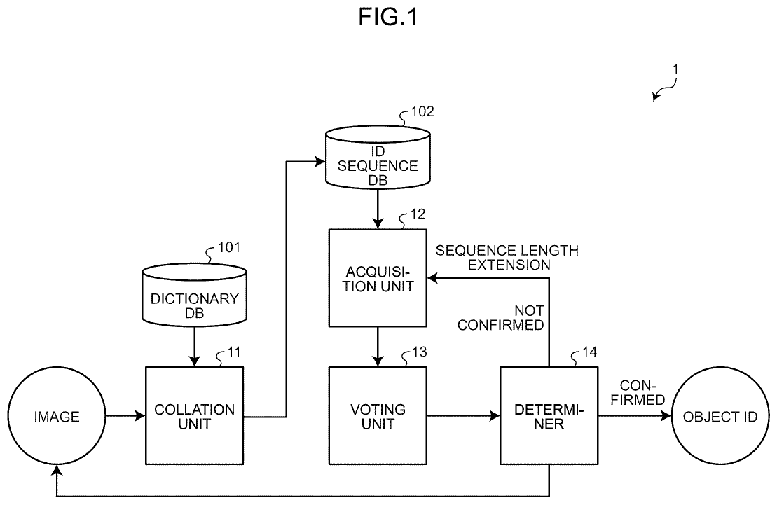

FIG. 1 is a diagram illustrating an example of a functional configuration of an information processing device 1 according to the first embodiment. An information processing device 1 of the first embodiment includes a collation unit 11, an acquisition unit 12, a voting unit 13, and a determiner 14. In addition, the information processing device 1 according to the first embodiment stores a dictionary database (DB) 101 and an ID sequence DB 102.

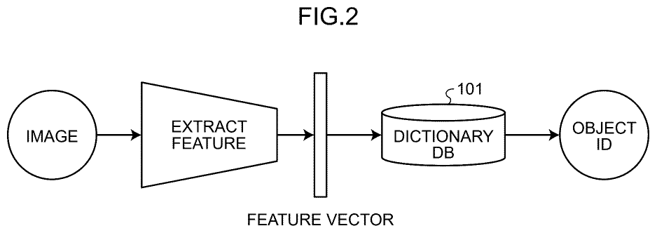

The collation unit 11 receives an input of an image. For example, the image is an image of one frame included in a video image captured in advance by a camera or the like. An example of a collation process by the collation unit 11 will be described with reference to FIG. 2.

FIG. 2 is a diagram illustrating an example of a collation process by the collation unit 11 according to the first embodiment. The collation unit 11 extracts a feature vector for collation from the image (feature extraction). The feature vector is, for example, a 512 dimensional vector.

As a feature extractor that performs feature extraction, for example, a neural network such as a convolutional neural network or a transformer is used. The feature extractor is trained by a method called metric learning. The metric learning is a method of learning a metric (distance, similarity, and the like) indicating a relationship between data, and can be applied to image classification, image retrieval, and the like. In the metric learning, metric is learned so that feature amounts of data having close meanings are close to each other and feature amounts of data having different meanings are far from each other. Methods such as Contrastive loss (Contrastive loss (Hadsell, Raia, Sumit Chopra, and Yann LeCun. “Dimensionality reduction by learning an invariant mapping.” 2006 IEEE computer society conference on computer vision and pattern recognition (CVPR'06). Vol. 2. IEEE, 2006.)), Triplet loss (Triplet loss (Schroff, Florian, Dmitry Kalenichenko, and James Philbin. “Facenet: A unified embedding for face recognition and clustering.” Proceedings of the IEEE conference on computer vision and pattern recognition. 2015.)), CosFace (CosFace (Wang, Hao, et al. “Cosface: Large margin cosine loss for deep face recognition.” Proceedings of the IEEE conference on computer vision and pattern recognition. 2018.)), and ArcFace (ArcFace (Deng, Jiankang, et al. “Arcface: Additive angular margin loss for deep face recognition.” Proceedings of the IEEE/CVF conference on computer vision and pattern recognition. 2019.)) are used for the metric learning.

The dictionary DB 101 (an example of a collation dictionary) stores a feature vector indicating a feature of an object identified by each object ID.

The collation unit 11 collates the object ID by comparing the feature vector obtained from the image with the feature vector of the object ID registered in the dictionary DB 101. For collation, cosine similarity is used, for example. When a feature vector of the input is q and a feature vector stored in the dictionary DB 101 is d, the cosine similarity is defined as the following Expression (1).

$$cos ( q , d ) = \frac{q \cdot d}{‖ q ‖ ‖ d ‖} \qquad ( 1 )$$

where, the sign of · indicates an inner product of the vector, and the norm of the denominator on the right side indicates the L2 norm. The collation unit 11 calculates cosine similarity between all the feature vectors in the dictionary DB 101, and sets the object ID associated with the feature vector having the highest similarity as the collated object ID. In the first embodiment, the cosine similarity obtained here is used as an estimated score.

In the example of FIG. 2, the feature extraction, the dictionary collation, and the cosine similarity are used, but the calculation example of the estimated score is not limited to the method of FIG. 2. For example, as a method of calculating the estimated score of the object included in each frame, a method such as a deep neural network, a support vector machine, or a random forest used in the class classification task may be used.

Returning to FIG. 1, the collation unit 11 adds the estimated score indicating the certainty of the collation result identified by the object ID to the sequence of the object IDs (an example of the identification information sequence) in association with the object ID. The ID sequence DB 102 stores a sequence of object IDs collated by the collation unit 11. For example, the ID sequence DB 102 stores an object ID and an estimated score for each identification information of an image. For example, the identification information of the image is a frame number for identifying a frame included in the video. The object ID collated in each frame and the estimated score of the object ID are stored in time sequence in the ID sequence DB 102.

The acquisition unit 12 acquires a sequence of the object ID and the estimated score from the ID sequence DB 102 according to the set sequence length. The acquisition unit 12 acquires the sequence in order from the latest sequence. The initial value of the sequence length is set to any value such as length 1.

The voting unit 13 obtains voting data by voting the object ID and the estimated score for each frame included in the ID sequence to be processed. The voting data is represented by a histogram of each of the plurality of object IDs. The estimated score is added to the histogram of each of the plurality of object IDs each time voting is performed. That is, the voting unit 13 adds the estimated score to the bin of the object ID (the voting destination label of the voting box).

Note that the voting unit 13 may add a predetermined number as the addition target instead of the estimated score. For example, in a case where the predetermined number is one, the number of votes cast for the object identified by the object ID is held in the bin of the object ID.

The determiner 14 determines whether an answer (collation result) based on the voting data indicating that the voting result is confirmed (finalized/settled). For example, in a case where an object included in a moving image (camera image) is collated, an answer indicating a collation result is decided. Therefore, in a case where a certain degree of certainty is obtained, the determiner 14 suspends the processing in the middle and decides an answer. For example, the degree of certainty is determined based on at least one of the number of votes and the voting ratio.

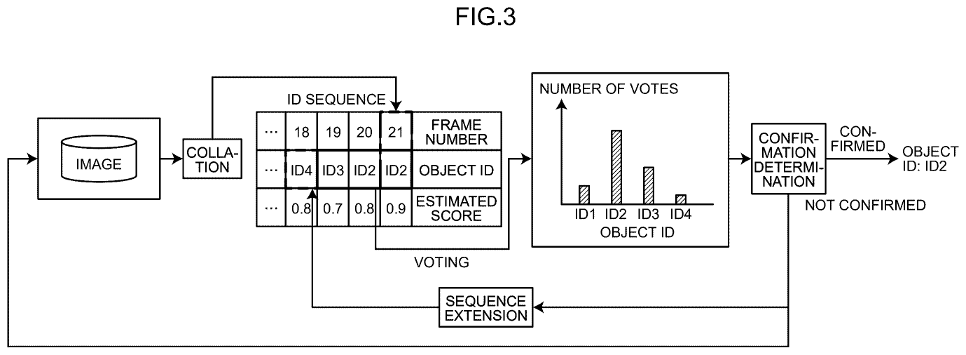

FIG. 3 is a diagram for explaining a flow of an information processing method according to the first embodiment. First, the collation unit 11 collates the object included in each frame, and stores the object ID and the estimated score of the collated object in time sequence in the ID sequence DB 102.

Next, the voting unit 13 votes on the object ID using the sequence of the object ID and the estimated score (an example of the voting target sequence) acquired by the acquisition unit 12. In the example of FIG. 3, the number of votes for each object ID is represented by a histogram.

Then, the determiner 14 determines whether to confirm the voting result of the object ID. In a case where the voting result is not confirmed, the determiner 14 requests the acquisition unit 12 to extend the sequence length of the ID sequence. In a case where the voting result is confirmed, the determiner 14 confirms the object ID based on the voting result.

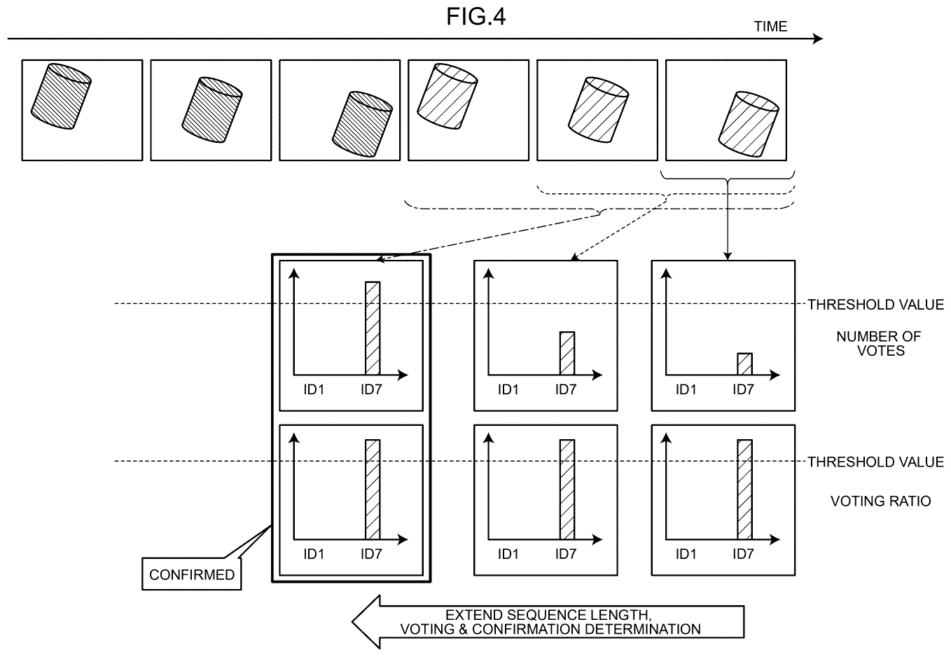

FIG. 4 is a diagram for explaining an example of the confirmation determination of a voting result by extension of an ID sequence according to the first embodiment. As illustrated in FIG. 4, the information processing device 1 of the first embodiment repeats voting by gradually extending the sequence length while going back to the past from the current time.

In the example of FIG. 4, a case where the voting result is confirmed by three votes is illustrated. In the example of FIG. 4, the initial value of the sequence length is one (frame), and the sequence length to be extended at the time of sequence extension is one.

In the example of FIG. 4, the determiner 14 determines whether to confirm the voting result by threshold value determination of the number of votes and the voting ratio. The number of votes indicates the number of votes cast for the object ID, and a predetermined value (for example, one) is added each time of voting on the object ID. The voting ratio is calculated by, for example, (the number of votes for each object ID)/(the total number of votes).

For example, the determiner 14 determines whether to confirm the collation based on at least one of the frequency (in the example of FIG. 4, the number of votes) of the histogram for each object ID for identifying the collation result and the voting ratio for each object ID for identifying the collation result. In the example of FIG. 4, since the number of votes is larger than a threshold value and the voting ratio is larger than a threshold value at the time point when the third voting is completed, the voting result is confirmed.

The voting process through extension of the ID sequence is repeatedly performed until the voting result is confirmed.

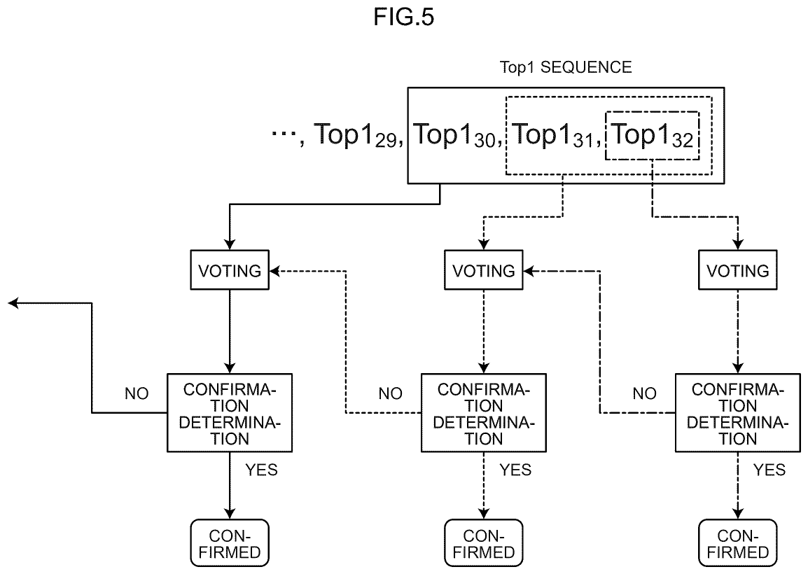

FIG. 5 is a diagram illustrating a voting and confirmation determination processing example according to the first embodiment. In Top1₃₂, Top1 indicates that one object with the highest degree of certainty of collation is obtained. In Top1₃₂, 32 indicates the 32nd frame. The example of FIG. 5 illustrates the voting and confirmation determination process through up to two sequence extensions in order to further improve the degree of certainty of the collation in the case of collating the object included in the 32nd frame.

Note that the length by which the sequence length is extended in a case where the voting result is not confirmed may be any length. For example, the length by which the sequence length is extended is one (one frame). Further, for example, all the lengths to be extended may have the same value, or may be changed according to the number of times of extension.

For example, the determiner 14 changes at least one of a threshold value for determining the number of votes and a threshold value for determining the voting ratio according to the length of the voting target sequence. Furthermore, for example, the determiner 14 changes at least one of a threshold value for determining the number of votes and a threshold value for determining the voting ratio according to the type of the collation target. The type of the collation target is identified from, for example, the object ID obtained by the collation process.

In a case where the maximum sequence length is reached as a result of a plurality of extensions, the determiner 14 ends the process of the frame to be determined, and the acquisition unit 12, the voting unit 13, and the determiner 14 shift the process to processing of the next frame.

A specific example of the extension control of the sequence length will be described below. The following sequence indicates a sequence length in the n-th determination.
1, 2, 3, 4, 5, 6, 7: six extensions are available. The extended length is always 1. The maximum sequence length is seven.
1, 3, 7, 11: three extensions are available. The extended length is 2, 4, 4. The maximum sequence length is 11.
1, 2, 3, 4, 5, 9, 15: six extensions are available. The extended length is 1, 1, 1, 1, 4, 6. The maximum sequence length is 15.

The determiner 14 decides the length of the n-th (1≤n≤N) voting target sequence based on the sequence length list indicating the length of the voting target sequence from the first voting to the N-th (N is an integer equal to or greater than one) voting indicating the maximum number of votes. Note that the optimum sequence length varies depending on the characteristic of the collation target. For example, the determiner 14 may decide the length of the n-th voting target sequence based on a sequence length list selected according to the type of the collation target from a plurality of sequence length lists defined according to the type of the collation target. Specifically, for example, the acquisition unit 12 extends the sequence length based on the sequence length list selected according to the type of the collation target from the above three sequence length lists.

### Example of Information Processing Method

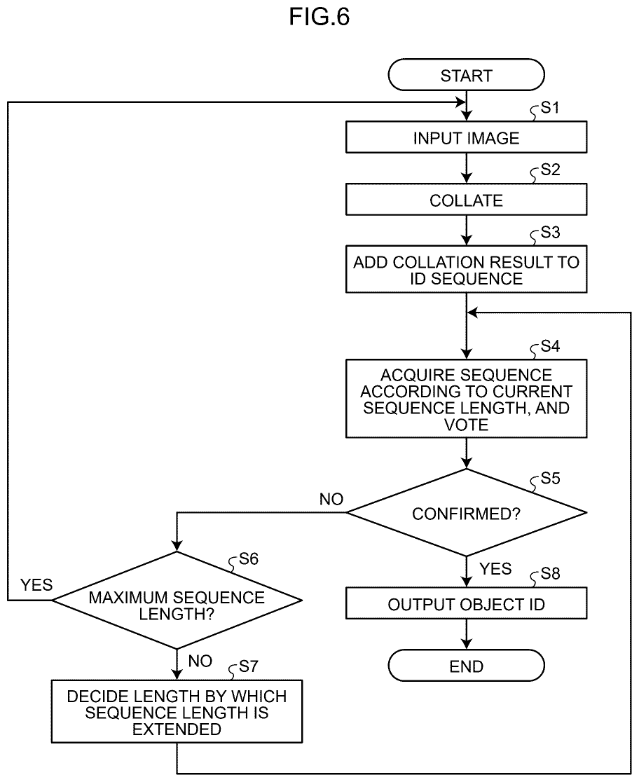

FIG. 6 is a flowchart illustrating an overall flow of the information processing method according to the first embodiment. First, the collation unit 11 receives an input of an image of one frame from a moving image such as a video image captured by the camera (step S1).

Next, the collation unit 11 collates the object ID by comparing the feature vector obtained from the image with the feature vector of the object ID registered in the dictionary DB 101 (step S2). Next, the collation unit 11 adds the collation result obtained in step S2 to the ID sequence stored in the ID sequence DB 102 (step S3).

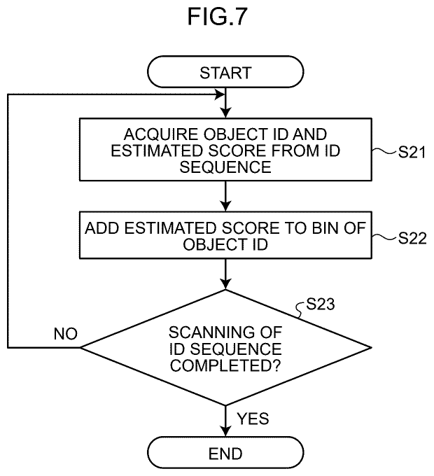

Next, the acquisition unit 12 acquires a sequence according to the current sequence length, and the voting unit 13 performs the voting process described above in the acquired sequence (step S4). Details of the voting process will be described later with reference to FIG. 7.

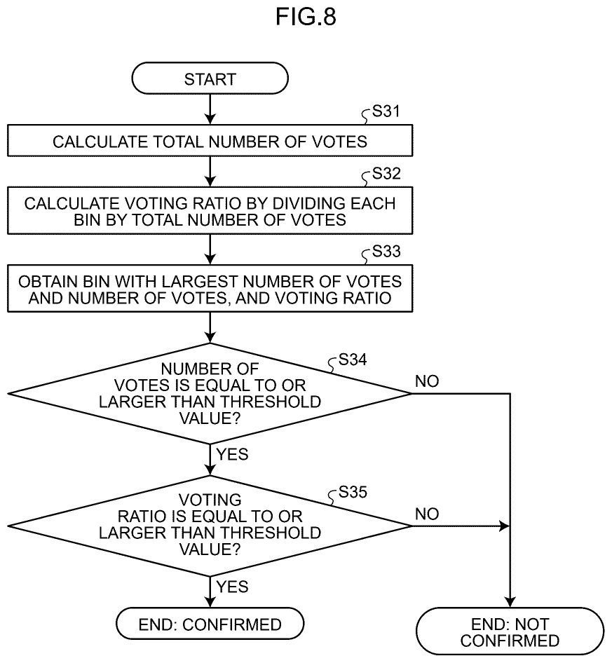

Next, the determiner 14 performs the determination process of determining whether to confirm the voting result (step S5). Details of the determination process will be described later with reference to FIG. 8. In a case where the voting result is confirmed (step S5, Yes), the determiner 14 outputs an answer (in the embodiments, an object ID) based on the voting result (step S8) and the process ends.

In a case where the voting result is not confirmed (step S5, Yes), the determiner 14 determines whether the current sequence length is the maximum sequence length (step S6). In a case where the current sequence length is not the maximum sequence length (step S6, No), the determiner 14 decides a length by which the sequence length is extended (step S7), and the process returns to step S4.

In a case where the sequence length is the maximum sequence length (step S6, Yes), the process returns to step S1, and the image of the next frame is processed.

FIG. 7 is a flowchart illustrating an example of a voting method of the first embodiment. First, the voting unit 13 acquires the object ID and the estimated score from the ID sequence to be processed (step S21). Next, the voting unit 13 adds the estimated score to the bin of the object ID (step S22). Next, the voting unit 13 determines whether scanning of the ID sequence to be processed is completed (step S23). In a case where the scanning is not completed (step S23, No), the process returns to step S21. In a case where the scanning is completed (step S23, Yes), the process ends.

FIG. 8 is a flowchart illustrating an example of the determination process according to the first embodiment. First, the determiner 14 calculates the total number of votes (step S31). Next, the determiner 14 obtains (calculates) the voting ratio of each object ID by dividing each bin (the number of votes of each object ID) by the total number of votes (step S32). Next, the determiner 14 identifies a bin (object ID) having the largest number of votes and obtains the number of votes and the voting ratio of the bin (step S33).

Next, the determiner 14 determines whether the number of votes obtained in step S33 is equal to or larger than a threshold value (step S34). In a case where the number of votes is not equal to or larger than the threshold value (step S34, No), the voting unit 13 determines that the collation of the object is not confirmed and ends the determination process.

In a case where the number of votes is equal to or larger than the threshold value (step S34, Yes), the determiner 14 determines whether the voting ratio obtained in step S33 is equal to or larger than the threshold value (step S35). In a case where the voting ratio is not equal to or larger than the threshold value (step S35, No), the determiner 14 determines that the collation of the objects is not confirmed and ends the determination process.

In a case where the voting ratio is equal to or greater than the threshold value (step S35, Yes), the determiner 14 confirms the collation of the objects as the object ID of the bin having the largest number of votes, and ends the determination process.

As described above, in the information processing device 1 of the first embodiment, the collation unit 11 collates the target included in the frame for each frame included in the moving image, and adds the identification information for identifying the collation result in the frame to the identification information sequence. The acquisition unit 12 acquires the voting target sequence indicating the identification information sequence to be voted from the identification information sequence in the order of the newness of the addition time of the identification information. The voting unit 13 obtains voting data by voting on the collation result using the identification information included in the voting target sequence. The determiner 14 determines whether to confirm the voting data, decides to extend the length of the voting target sequence in a case where the voting data is not confirmed, and outputs a collation result based on the voting data in a case where the voting data is confirmed. The acquisition unit 12 extends a length of the voting target sequence according to the decision by the determiner 14. In a case where the length of the voting target sequence is extended, the voting unit 13 continues voting on the collation result using the identification information included in the extended voting target sequence.

As a result, according to the information processing device 1 of the first embodiment, the processing time until the collation of the target is confirmed can be further shortened without lowering the collation accuracy.

For example, conventional best shot selection has a problem that the time until collation confirmation is not considered. This is because the collation is not completed unless the best shot condition is satisfied. On the other hand, by introducing the voting mechanism of the first embodiment, both the accuracy of collation and the confirmation time can be achieved.

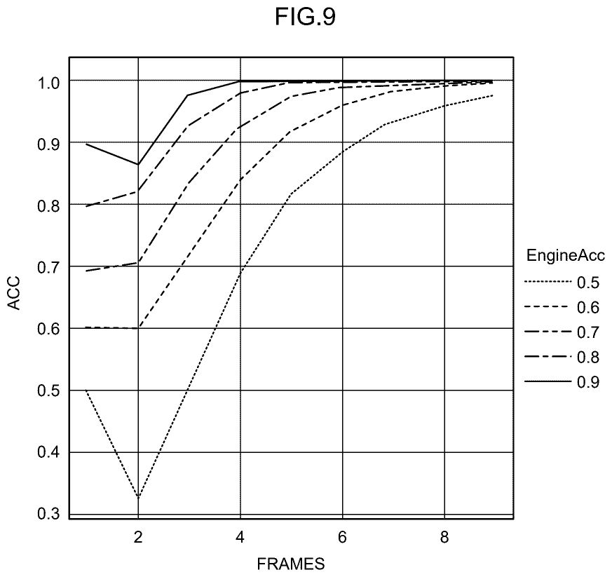

FIG. 9 is a diagram illustrating a relationship between the number of votes and the collation accuracy according to the first embodiment. In the example of FIG. 9, the relationship between the number of frames and the final correct answer rate is plotted for each accuracy of the engine (correct answer rate of collation).

In the case of two-frame voting, it is considered that the accuracy lowers because the voting is split and the deciding power is lowered; however it can be seen that the accuracy is greatly improved in three or more frames. Certainly, the higher the accuracy of the engine alone, the faster the convergence of the final correct answer rate. As can be seen from FIG. 9, even when there is only 50% correct answer rate per frame, it can be seen that a correct answer rate close to 90% can be obtained by six-frame voting.

It is considered that even when the best shot is selected, the 90% correct answer rate is hardly obtained for the 50% correct answer rate per frame, however the correct answer rate can be reliably increased by voting. Even in a situation where collation is not completed no matter how much time passes for the best shot as described above, the collation can be achieved by introducing the voting mechanism.

Furthermore, in the information processing device 1 of the first embodiment, the voting confirmation process can be further stabilized.

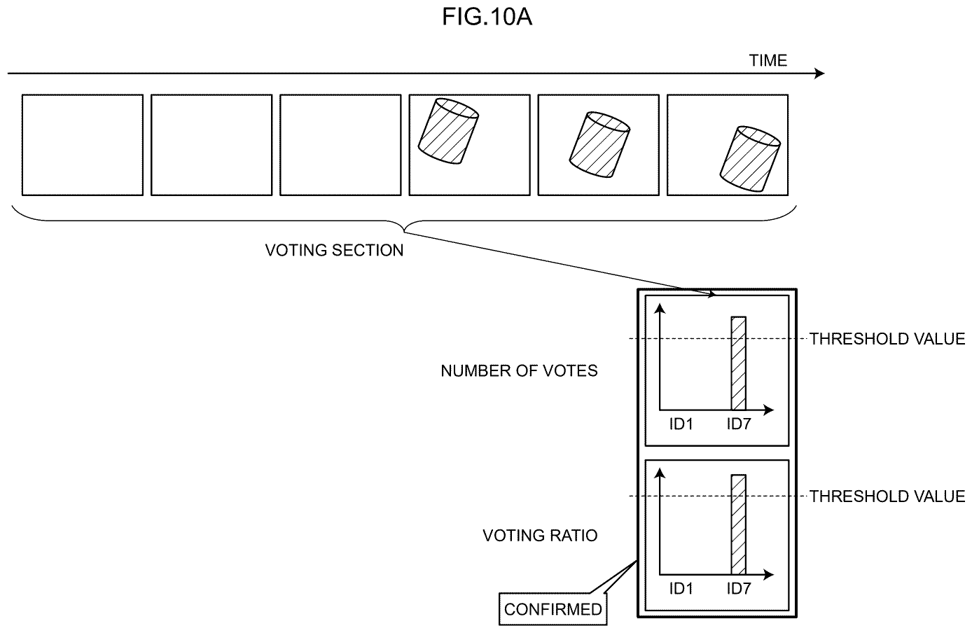

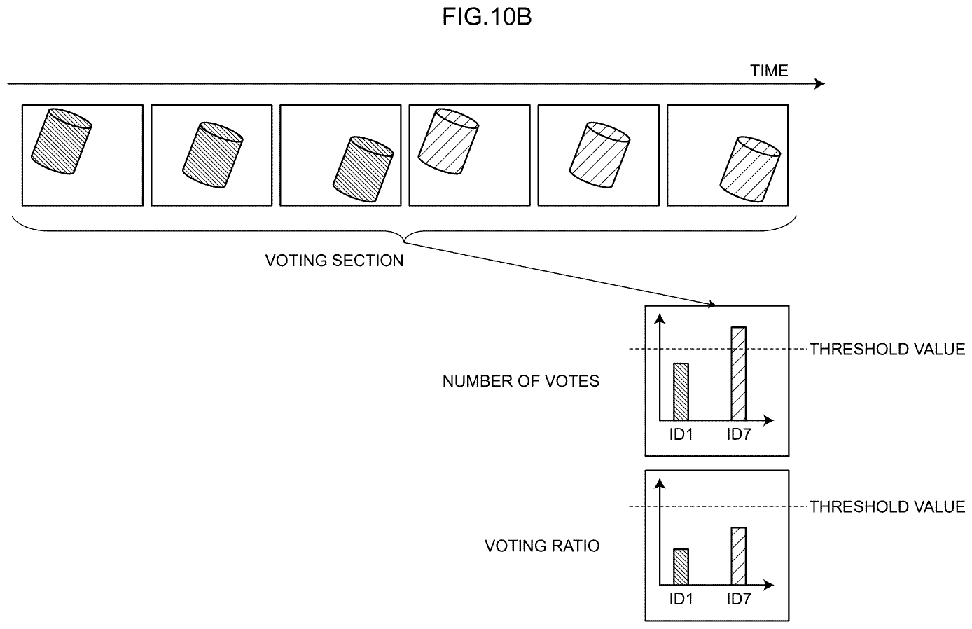

FIGS. 10A and 10B are diagrams for describing stabilization of the voting confirmation process according to the first embodiment. For example, in a case where the voting section is fixed to six frames (in a case where the length of the ID sequence described above is six), in the example of FIG. 10A, an object appears from the middle of the voting section, but since there is one object, the voting result is confirmed.

On the other hand, as illustrated in FIG. 10B, in a case where the first object appears first and the second object appears next, when the voting section is fixed to six frames, the voting is split, and thus the voting result cannot be confirmed.

As illustrated in FIG. 4 described above, the information processing device 1 of the first embodiment repeats voting while gradually extending the sequence length back from the current time to the past, so that the voting confirmation process can be further stabilized as compared with a case where the voting section is fixed. That is, as illustrated in FIG. 4 described above, the information processing device 1 of the first embodiment can also expect an effect of stabilizing the voting behavior while placing importance on the current information by gradually extending the sequence from the current time toward the past.

### First Modification of First Embodiment

Next, the first modification of the first embodiment will be described. In the description of the first modification, the same description as that of the first embodiment will be omitted, and portions different from those of the first embodiment will be described.

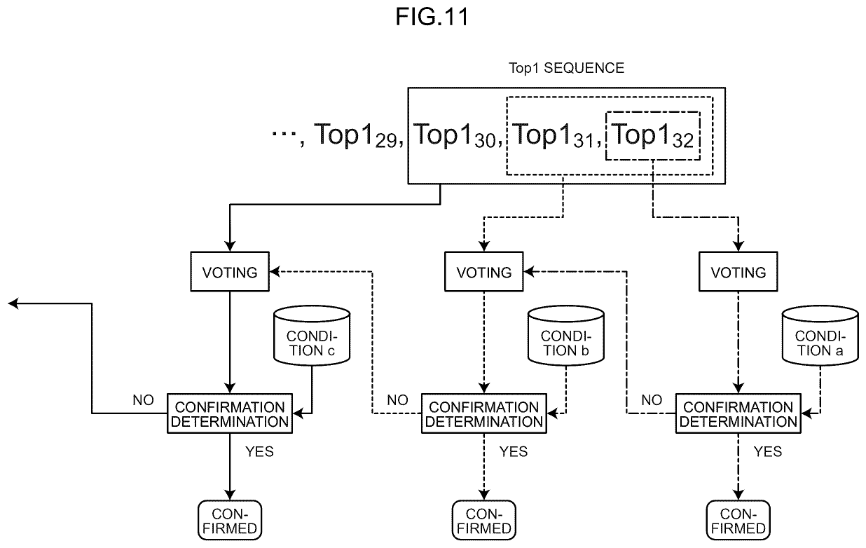

FIG. 11 is a diagram illustrating a voting and confirmation determination processing example according to the first modification of the first embodiment. The example of FIG. 11 illustrates the voting and confirmation determination process through up to two sequence extensions in order to further improve the degree of certainty of collation in a case where an object included in the 32nd frame is collated.

As illustrated in FIG. 11, the determiner 14 of the first modification changes the confirmation determination conditions a to c according to the sequence length. As described in the first embodiment, the confirmation determination conditions a to c are the threshold value of the number of votes, the threshold value of the voting ratio, and the like.

According to the first modification, the determination condition can be changed to a more appropriate condition according to the length of the sequence length. For example, as the number of votes increases, the determination condition can be controlled to be loosened.

### Second Modification of First Embodiment

Next, the second modification of the first embodiment will be described. In the description of the second modification, the description similar to that of the first embodiment will be omitted, and portions different from those of the first embodiment will be described.

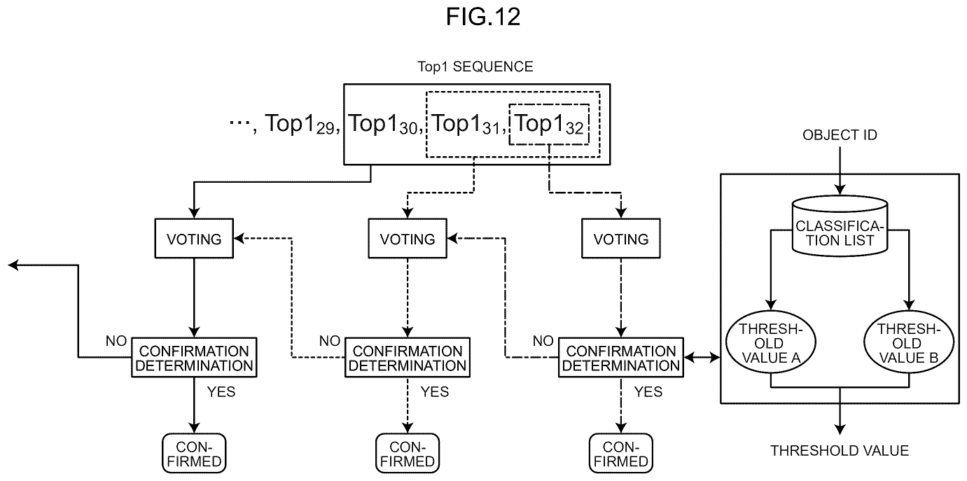

FIG. 12 is a diagram illustrating a voting and confirmation determination processing example according to the second modification of the first embodiment. The example of FIG. 12 illustrates the voting and confirmation determination process through up to two sequence extensions in order to further improve the degree of certainty of collation in a case where an object included in the 32nd frame is collated.

As illustrated in FIG. 12, the determiner 14 of the second modification uses the threshold value A or B according to the classification of the object ID based on the classification list, and performs the confirmation determination. For example, in a case where it is known in advance that the identification rate is different for each object ID, the determiner 14 holds a threshold value corresponding to each of a group having a good identification rate and a group having a poor identification rate. For example, the threshold value is stored in the classification list DB in association with the classification defined in the classification list.

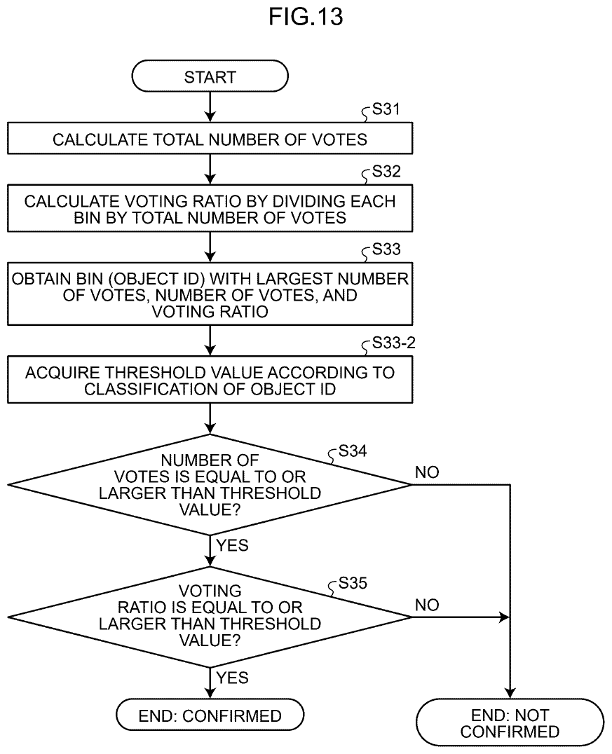

FIG. 13 is a flowchart illustrating an example of the determination process of the second modification of the first embodiment. In the second modification, step S33-2 is added to the flow of the first embodiment (FIG. 8). The determiner 14 of the second modification acquires the threshold value A or B from the classification list DB according to the classification of the object ID based on the classification list (step S33-2).

Steps other than step S33-2 are the same as those in the first embodiment, and thus descriptions thereof will be omitted.

According to the second modification, it is possible to expect an effect that the confirmation determination of the voting result can be performed more efficiently. For example, when the threshold value is loosened for a group with a lower identification rate, the time required for the confirmation determination can be made uniform.

### Second Embodiment

Next, the second embodiment will be described. In the description of the second embodiment, the description similar to that of the first embodiment will be omitted, and the description different from that of the first embodiment will be described. In the second embodiment, a case where a collation result display function is further provided will be described.

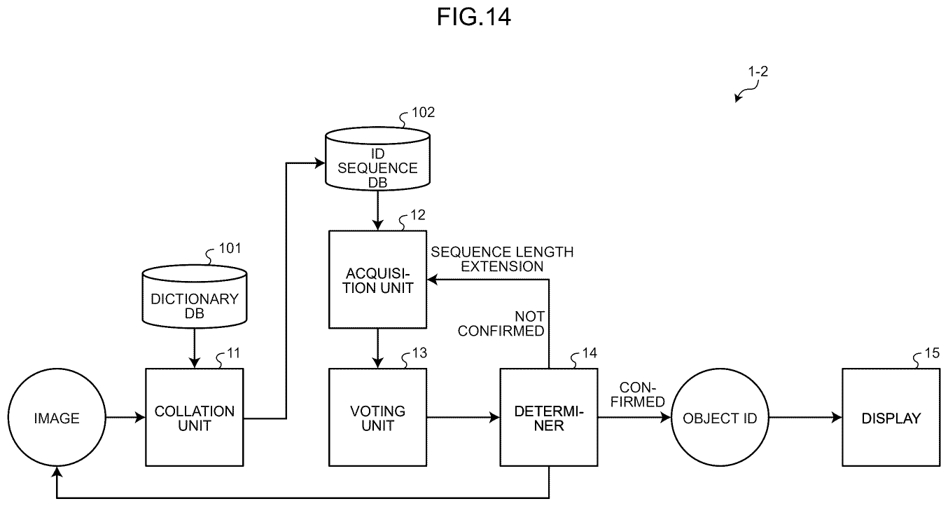

Example of functional configuration FIG. 14 is a diagram illustrating an example of a functional configuration of an information processing device 1-2 according to the second embodiment. An information processing device 1-2 of the second embodiment includes a collation unit 11, an acquisition unit 12, a voting unit 13, a determiner 14, and a display 15. In addition, the information processing device 1 according to the first embodiment stores a dictionary DB 101 and an ID sequence DB 102.

In the information processing device 1-2 of the second embodiment, a display 15 is added to the configuration of the first embodiment (FIG. 1). The display 15 displays display information including the object ID determined by the determiner 14.

According to the second embodiment, the user can immediately check the confirmed collation result. As a result, the user can check whether the confirmed collation result is correct by checking the display information.

### Third Embodiment

Next, the third embodiment will be described. In the description of the third embodiment, the description similar to that of the first embodiment will be omitted, and the description different from that of the first embodiment will be described. In the third embodiment, a case where the collation target is a face will be described.

### Example of Functional Configuration

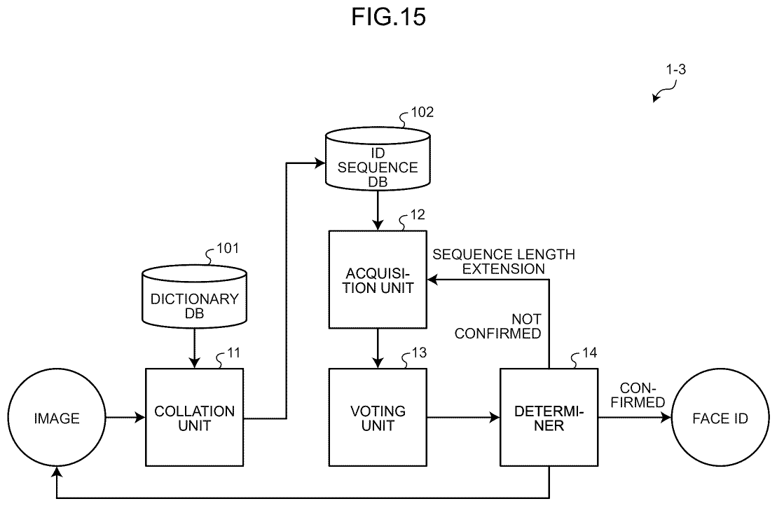

FIG. 15 is a diagram illustrating an example of a functional configuration of an information processing device 1-3 according to the third embodiment. The functional configuration of the third embodiment is the same as that of the first embodiment. In the third embodiment, for example, the collation unit 11 collates the face from the frame included in the moving image. The collation unit 11 collates the face using the dictionary DB 101 that stores identification information (face ID) for identifying a face to be collated, and acquires the face ID for identifying a collation result in the frame from the dictionary DB 101. The collation unit 11 stores the face ID obtained for each frame in the ID sequence DB 102.

In a case where the collation is confirmed, the determiner 14 outputs the confirmed face ID.

### Fourth Embodiment

Next, the fourth embodiment will be described. In the description of the fourth embodiment, the description similar to that of the first embodiment will be omitted, and the description different from that of the first embodiment will be described. In the fourth embodiment, a case where the collation target is a person will be described.

### Example of Functional Configuration

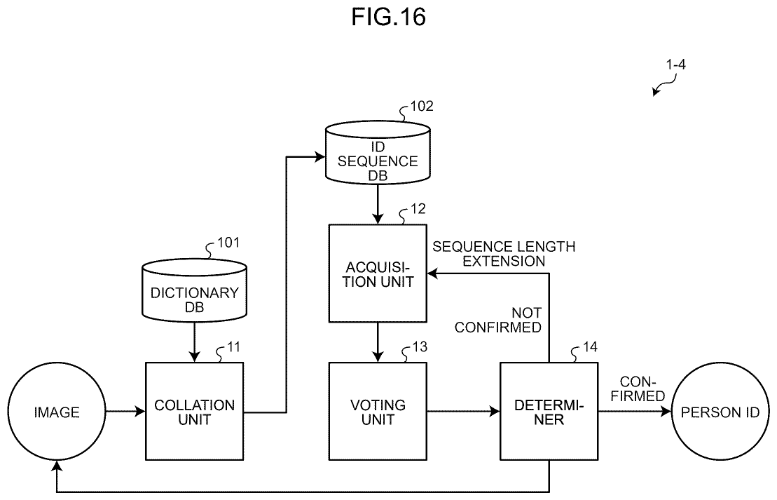

FIG. 16 is a diagram illustrating an example of a functional configuration of an information processing device 1-4 according to the fourth embodiment. The functional configuration of the fourth embodiment is the same as that of the first embodiment. In the fourth embodiment, the collation unit 11 collates a person from a frame included in a moving image, for example. The collation unit 11 collates a person using the dictionary DB 101 that stores identification information (person ID) for identifying a person to be collated, and acquires the person ID for identifying a collation result in the frame from the dictionary DB 101. The collation unit 11 stores the person ID obtained for each frame in the ID sequence DB 102.

In a case where the collation is confirmed, the determiner 14 outputs the confirmed person ID.

### Fifth Embodiment

Next, the fifth embodiment will be described. In the description of the fifth embodiment, the description similar to that of the first embodiment will be omitted, and the description different from that of the first embodiment will be described. In the fifth embodiment, a case where the collation target is a vehicle (for example, an automobile or the like) will be described.

### Example of Functional Configuration

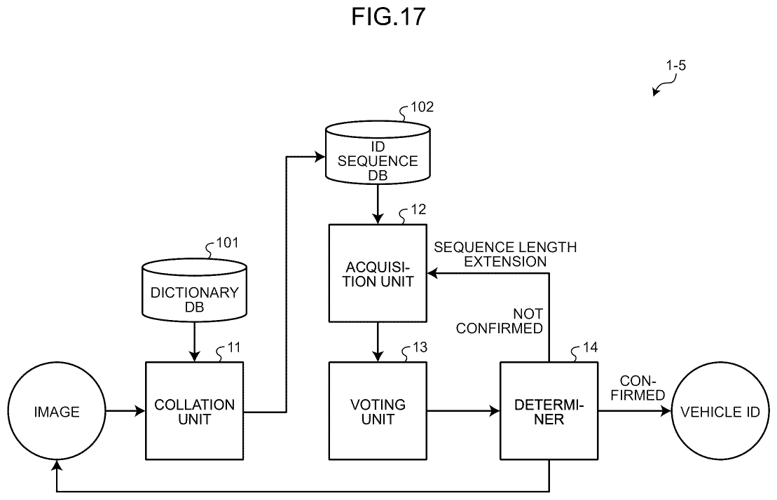

FIG. 17 is a diagram illustrating an example of a functional configuration of an information processing device 1-5 according to the fifth embodiment. The functional configuration of the fifth embodiment is the same as that of the first embodiment. In the fifth embodiment, for example, the collation unit 11 collates the vehicle from the frame included in the moving image. The collation unit 11 collates the vehicle using the dictionary DB 101 that stores identification information (vehicle ID) for identifying the vehicle to be collated, and acquires the vehicle ID for identifying the collation result in the frame from the dictionary DB 101. The collation unit 11 stores the vehicle ID obtained for each frame in the ID sequence DB 102.

In a case where the collation is confirmed, determiner 14 outputs the confirmed vehicle ID.

### Sixth Embodiment

Next, the sixth embodiment will be described. In the description of the sixth embodiment, the description similar to that of the first embodiment will be omitted, and the description different from that of the first embodiment will be described. In the sixth embodiment, a case where the collation target is a visual question answering (VQA) target included in the image of each frame will be described.

### Example of Functional Configuration

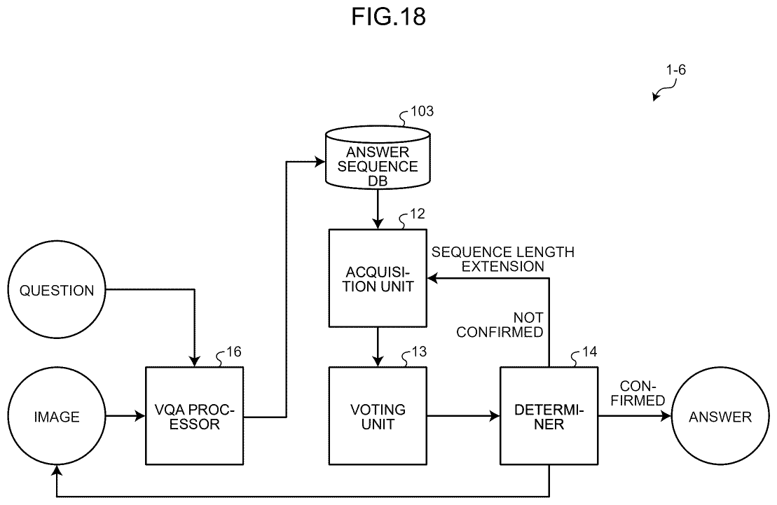

FIG. 18 is a diagram illustrating an example of a functional configuration of an information processing device 1-6 according to the sixth embodiment. An information processing device 1-6 of the sixth embodiment includes an acquisition unit 12, a voting unit 13, a determiner 14, and a VQA processor 16. In the sixth embodiment, the VOA processor 16 is provided instead of the collation unit 11 and the dictionary DB 101.

The VQA processor 16 performs a VOA process on the VQA target included in the image. The VOA is a process of determining the content from the image and answering the question in response to any question. The greatest feature of VQA is that questions are given in free-form natural language text. As a result, theoretically, when a matter can be expressed by text, the embodiment has high versatility that can cope with any matter. Identification information (answer ID) for identifying the answer obtained for each frame and a sequence of the estimated score are stored in an answer sequence DB 103.

The voting unit 13 votes on the answer ID using the answer ID for identifying the answer obtained for each frame and a sequence of the estimated score.

The determiner 14 determines whether the answer is confirmed, and outputs the answer identified by the confirmed answer ID in a case where the answer is confirmed.

### Seventh Embodiment

Next, the seventh embodiment will be described. In the description of the seventh embodiment, the description similar to that of the first embodiment will be omitted, and the description different from that of the first embodiment will be described. In the seventh embodiment, an embodiment will be described in which object detection and tracking are performed so that even a case where a plurality of objects appears in an image can be handled.

### Example of Functional Configuration

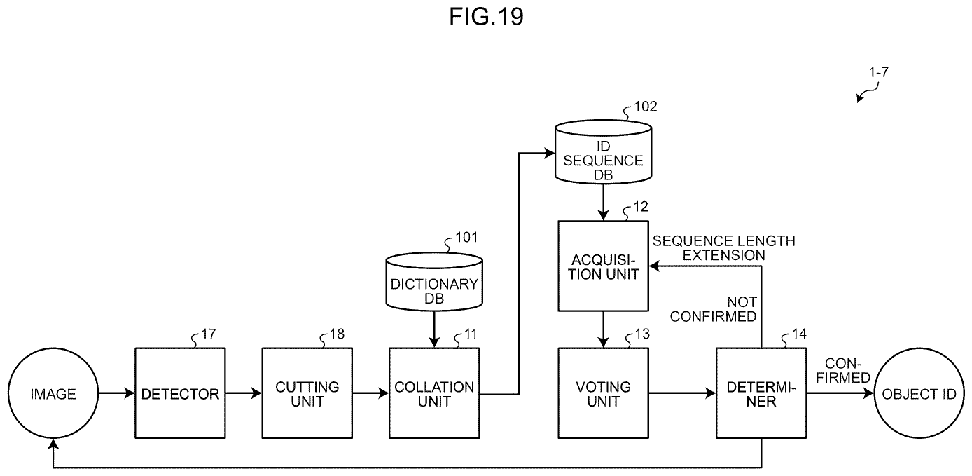

FIG. 19 is a diagram illustrating an example of a functional configuration of an information processing device 1-7 according to the seventh embodiment. An information processing device 1-7 of the seventh embodiment includes a collation unit 11, an acquisition unit 12, a voting unit 13, a determiner 14, a detector 17, and a cutting unit 18. In addition, the information processing device 1-7 of the seventh embodiment stores a dictionary DB 101 and an ID sequence DB 102. The information processing device 1-7 of the seventh embodiment additionally includes the detector 17 and the cutting unit 18.

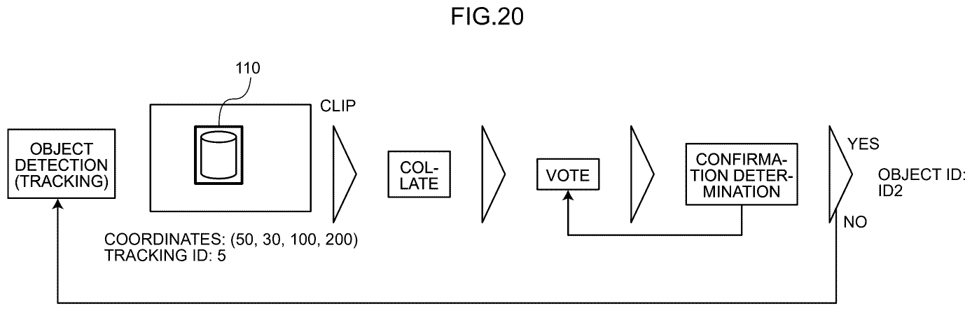

FIG. 20 is a diagram for explaining a flow of an information processing method according to the seventh embodiment. As in the first embodiment, the information processing device 1-7 of the seventh embodiment introduces a voting mechanism to achieve both improvement in collation accuracy and reduction in time until collation confirmation.

The operation of the information processing device 1-7 according to the seventh embodiment will be described with reference to FIGS. 19 and 20.

As illustrated in FIG. 20, the detector 17 first detects a tracking target region 110 including the tracking target (in the seventh embodiment, an object) from a one frame image included in the moving image. For example, “Faster R-CNN (Girshick, Ross. “Fast r-cnn.” Proceedings of the IEEE international conference on computer vision. 2015.)” or the like is used for object detection. The tracking target region 110 is represented by, for example, coordinate information indicating two vertexes (for example, a set of a lower left vertex of the rectangle and an upper right vertex of the rectangle) identifying a rectangular region. In addition, the detected object is identified by a tracking ID. In a case where there is a plurality of detected objects, the plurality of objects as the tracking targets is managed by the tracking list including the plurality of tracking IDs.

Next, the cutting unit 18 clips the tracking target region 110 for each tracking ID from the frame.

Next, the collation unit 11 collates (estimates) the object identified by the tracking ID, thereby obtaining the object ID and the estimated score indicating the certainty of the estimation of the object ID. For example, the estimated score is represented by a numerical value of 0 or more and 1 or less, and the larger the numerical value, the higher the accuracy of estimation.

Collation unit 11 collates the tracking target (the object identified by the tracking ID) using a collation dictionary (in the seventh embodiment, the dictionary DB 101) that stores identification information (in the seventh embodiment, the object ID) for identifying the collation target, and acquires the object ID for identifying the collation result in the frame of the tracking target from the dictionary DB 101. Specifically, first, the collation unit 11 extracts the feature amount of the tracking target included in the tracking target region 110. Then, the collation unit 11 collates the tracking target based on the similarity between the feature amount of the tracking target and the feature amount stored in the dictionary DB 101, thereby acquiring the object ID for identifying the collation result in the frame of the tracking target from the dictionary DB 101.

The collation unit 11 stores the object ID and the estimated score obtained for each tracking ID in each frame in the ID sequence DB 102.

In subsequent processing of the acquisition unit 12, the voting unit 13, and the determiner 14, the process similar to that of the first embodiment is performed for each object identified by the tracking ID. That is, in a case where there is a plurality of objects in the image, each object is identified by the tracking ID, and the process similar to that of the first embodiment is performed on each object.

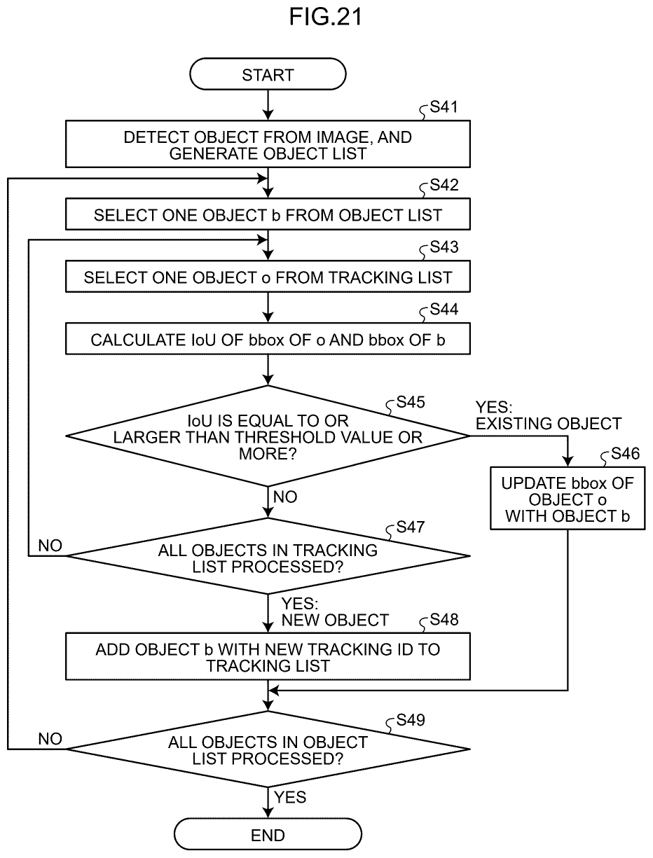

FIG. 21 is a flowchart illustrating an example of object detection and tracking processing according to the seventh embodiment. At the start of the process the detector 17 selects an image, of one frame, to be processed and a tracking list obtained by processing the image up to one previous frame.

The tracking list is a list of a tracking ID and box coordinates (bbox: Bounding Box) associated with the tracking ID, and indicates where an object being tracked exists. The format of the box coordinates is, for example, coordinates (upper left x coordinate, upper left y coordinate, lower right x coordinate, lower right y coordinate) for identifying the rectangle.

In the object detection and tracking process as illustrated in FIG. 20, a region corresponding to an object is extracted and tracked. In normal object detection, there are labels of various objects such as a person and a car, but in the detector 17 of the seventh embodiment, all the labels are handled as one object without being distinguished (in the process of the detector 17, the presence or absence of any object is detected and tracked without detecting the type of the object).

Note that an object detected in the first frame included in the moving image to be processed is set as an initial value of the tracking list.

First, the detector 17 detects an object from the image and generates an object list including the detected object (step S41). In a case where an object is found, the detector 17 (object detection engine) returns box coordinates indicating a rectangle including the object. In the object detection in step S41, an object list in which 0 or more detected box coordinates (bboxes) are stored is generated.

Next, the detector 17 selects one object b to be processed from the object list generated in step S41 (step S42). Next, the detector 17 selects one object o to be processed from the tracking list (step S43).

For tracking an object, a method of tracking a previous object having the largest overlap of the bboxes using Intersection over Union (IoU) is used. That is, a tracking method is used in which it is determined that the object o and the object b are more likely to be the same object as the overlap of the bboxes is larger.

Specifically, the detector 17 calculates the IoU (overlapping state) of the bbox of the object o and the bbox of the object b (step S44).

When IOU is equal to or larger than the threshold value (step S45, Yes), the detector 17 updates the bbox of the object o in the tracking list with the bbox of the object b (step S46), and the process proceeds to step S49.

On the other hand, when the IoU is less than the threshold value (step S45, No), the detector 17 determines whether all the objects o included in the tracking list are processed (step S47). In a case where all the objects are not processed (step S47, No), the process returns to step S43, and one object o with an unprocessed tracking ID is selected from the tracking list.

In a case where all the objects are processed (step S47, Yes), the detector 17 adds the object b with the new tracking ID to the tracking list as a new object (step S48). Next, the detector 17 determines whether all the objects b included in the object list are processed (step S49). In a case where all the objects are not processed (step S49, No), the process returns to step S42, and one unprocessed object b is selected from the object list.

In a case where all the objects are processed (step S49, Yes), the process on the image of the one frame ends.

As described above, in the information processing device 1-7 according to the seventh embodiment, the detector 17 detects the tracking target region 110 including the tracking target from the frame. Then, the collation unit 11 adds identification information for identifying the collation result obtained by collating the tracking target in each of the tracking target regions 110 to the identification information sequence stored for each tracking target.

### Eighth Embodiment

Next, the eighth embodiment will be described. In the description of the eighth embodiment, the description similar to that of the first embodiment will be omitted, and the description different from that of the first embodiment will be described. In the eighth embodiment, an embodiment will be described in which an image is divided into grids so that even a case where a plurality of objects appears in the image can be handled.

### Example of Functional Configuration

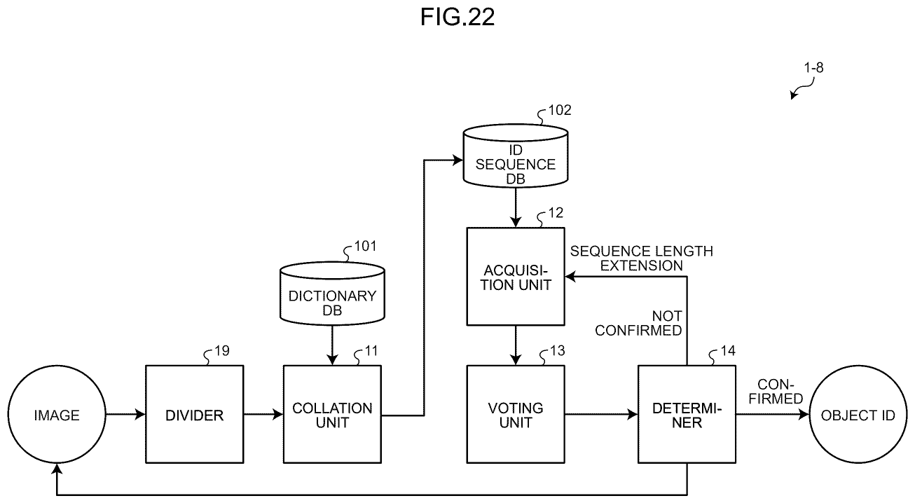

FIG. 22 is a diagram illustrating an example of a functional configuration of an information processing device 1-8 according to the eighth embodiment. An information processing device 1-8 of the eighth embodiment includes a collation unit 11, an acquisition unit 12, a voting unit 13, a determiner 14, and a divider 19. In addition, the information processing device 1-8 according to the eighth embodiment stores a dictionary DB 101 and an ID sequence DB 102.

The information processing device 1-8 according to the eighth embodiment additionally includes the divider 19. The divider 19 divides the image into grids.

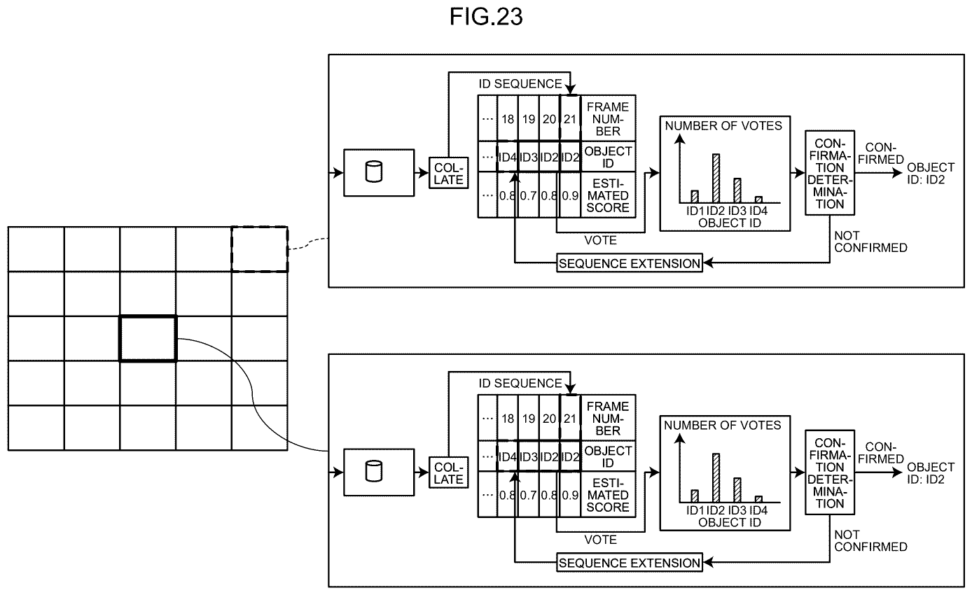

FIG. 23 is a diagram illustrating an example of division processing by the divider 19 according to the eighth embodiment. For example, the divider 19 divides the image into five vertical divisions and five horizontal divisions, thereby dividing the image into a total of 25 grids. Note that instead of dividing the image into a certain size, for example, a division method may be used in which the size of the grid is changed between the central portion and the peripheral portion of the screen. In the fisheye camera, an object appears larger toward the center of the screen. In a case where it is desired to equalize the size of the object with respect to the grid, the grid in the central portion may be made larger than the grid in the peripheral portion, and the grid in the peripheral portion may be made smaller than the grid in the central portion.

As illustrated in FIG. 23, the subsequent collation process is performed independently for each grid. That is, in the example of FIG. 23, the upper right grid and the center grid are processed independently of each other.

As described above, in the information processing device 1-8 according to the eighth embodiment, the divider 19 divides a frame into a plurality of divided regions (in the example of FIG. 8, the grids). Then, the collation unit 11 adds identification information for identifying the collation result obtained by collating the collation target in each of the divided regions to the identification information sequence stored for each of the divided regions.

According to the eighth embodiment, even in a case where a plurality of objects appears in an image, it is possible to cope with the processing for each grid.

### Ninth Embodiment

Next, the ninth embodiment will be described. In the description of the ninth embodiment, the description similar to that of the first embodiment will be omitted, and the description different from that of the first embodiment will be described. In the ninth embodiment, a case will be described in which a function of feeding back the voting and confirmation determination process to the user is further included.

### Example of Functional Configuration

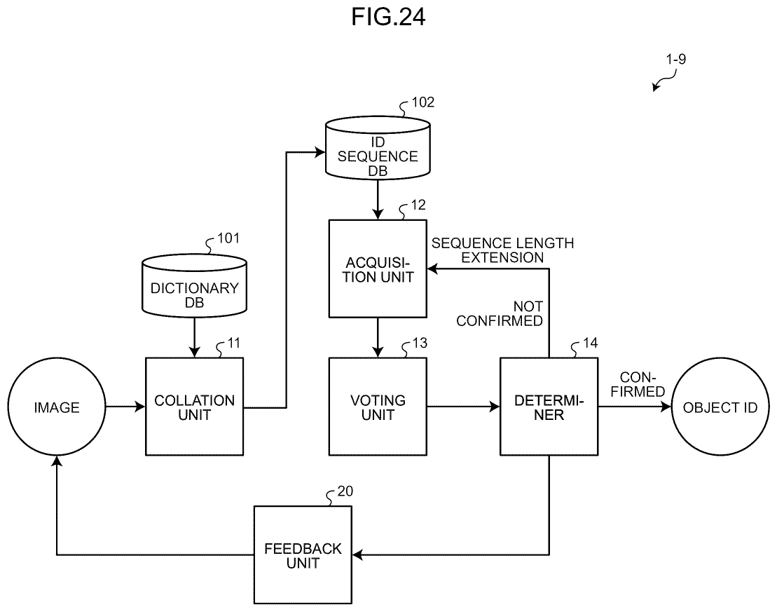

FIG. 24 is a diagram illustrating an example of a functional configuration of an information processing device 1-9 according to the ninth embodiment. An information processing device 1-9 of the ninth embodiment includes a collation unit 11, an acquisition unit 12, a voting unit 13, a determiner 14, and a feedback unit 20. In addition, the information processing device 1-9 according to the ninth embodiment stores a dictionary DB 101 and an ID sequence DB 102.

The information processing device 1-9 according to the ninth embodiment additionally includes the feedback unit 20. For example, the feedback unit 20 displays display information including the feedback information on the display device to feed back the voting and confirmation determination process to the user.

The feedback information includes, for example, a histogram (see, for example, FIG. 3) indicating the number of votes for each object ID. In addition, for example, the feedback information includes a progress bar (arrival status until the number of votes exceeds a threshold value) indicating the current number of votes and the progress status until collation confirmation.

For example, in a case where the collation is not confirmed for a certain period of time, the feedback unit 20 outputs feedback information including voting data of top K (K is an integer equal to or greater than one) object IDs of the voting result to a display device or the like.

According to the information processing device 1-9 of the ninth embodiment, for example, the user can perform adjustment such as advancing the time until collation confirmation by adjusting the threshold value used for collation confirmation based on the feedback information. As a result, it is possible to solve a problem that it takes much time to confirm the collation or the collation is not confirmed because the collation accuracy is emphasized.

Finally, an example of a hardware configuration of the information processing device 1 (1-2 to 1-9) according to the first to ninth embodiments will be described.

### Example of Hardware Configuration

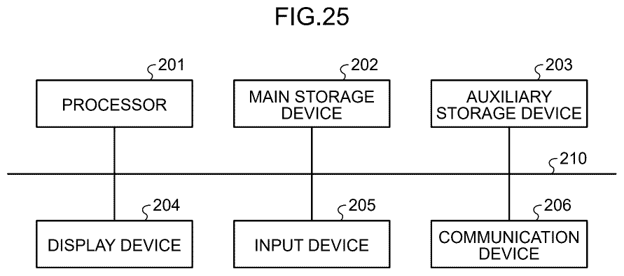

FIG. 25 is a diagram illustrating an example of a hardware configuration of the information processing device 1 (1-2 to 1-9) according to the first to ninth embodiments. The information processing device 1 includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

Note that the information processing device 1 may not include part of the above configuration. For example, in a case where the information processing device 1 can use an input function and a display function of an external device, the information processing device 1 may not include the display device 204 and the input device 205.

The processor 201 executes a program read from the auxiliary storage device 203 to the main storage device 202. The main storage device 202 is a memory such as a read only memory (ROM) and a random access memory (RAM). The auxiliary storage device 203 is a hard disk drive (HDD), a memory card, or the like.

The display device 204 is, for example, a liquid crystal display or the like. The input device 205 is an interface for operating the information processing device 1. Note that the display device 204 and the input device 205 may be realized by a touch panel or the like having the display function and the input function. The communication device 206 is an interface for communicating with other devices.

For example, the program executed by the information processing device 1 is a file in an installable format or an executable format, is recorded in a computer-readable storage medium such as a memory card, a hard disk, a CD-RW, a CD-ROM, a CD-R, a DVD-RAM, and a DVD-R, and is provided as a computer program product.

Furthermore, for example, the program executed by the information processing device 1 may be stored in a computer connected to a network such as the Internet and provided by being downloaded via the network.

Furthermore, for example, the program executed by the information processing device 1 may be provided via a network such as the Internet without being downloaded. Specifically, for example, it may be configured by an application service provider (ASP) type cloud service.

Furthermore, for example, the program of the information processing device 1 may be provided by being incorporated in a ROM or the like in advance.

The program executed by the information processing device 1 has a module configuration including functions that can be realized by the program among the above-described functional configurations. As actual hardware, the processor 201 reads a program from a storage medium and executes the program, whereby the functional blocks are loaded on the main storage device 202. That is, the functional blocks are generated on the main storage device 202.

Note that some or all of the above-described functions may not be implemented by software but may be implemented by hardware such as an integrated circuit (IC).

In addition, each function may be realized using a plurality of processors 201, and in this case, each processor 201 may realize one of the functions or may realize two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
a collation unit configured to collate a target included in a frame for each frame included in a moving image, and add identification information for identifying a collation result in the frame to an identification information sequence;
an acquisition unit configured to acquire voting target sequences indicating identification information sequences to be voted from the identification information sequence in an order of newness of an addition time of the identification information;
a voting unit configured to obtain voting data by voting on a collation result using identification information included in the voting target sequence; and
a determiner configured to determine whether to confirm the voting data, decide to extend a length of the voting target sequence in a case where the voting data is not confirmed, and output a collation result based on the voting data in a case where the voting data is confirmed, wherein
the acquisition unit extends a length of the voting target sequence according to a decision by the determiner, and
in a case where the length of the voting target sequence is extended, the voting unit continues voting on the collation result using identification information included in the extended voting target sequence.

2. The information processing device according to claim 1, wherein
the determiner decides a length of a n-th voting target sequence, where 1≤n≤N, based on a sequence length list indicating a length of the voting target sequence from a first voting to a N-th voting indicating a maximum number of votes, where N is an integer equal to or greater than one.

3. The information processing device according to claim 2, wherein
the determiner decides a length of the n-th voting target sequence based on the sequence length list selected according to a type of the target from a plurality of the sequence length lists defined according to a type of the target.

4. The information processing device according to claim 1, wherein
the voting data is represented by a histogram of each of a plurality of pieces of the identification information, and
a predetermined number is added to a histogram of each of the plurality of pieces of identification information each time voting is performed.

5. The information processing device according to claim 1, wherein
the collation unit adds an estimated score indicating certainty of a collation result identified by the identification information to the identification information sequence in association with the identification information,
the voting data is represented by a histogram of each of a plurality of pieces of identification information, and
the estimated score is added to the histogram of each of the plurality of pieces of identification information each time voting is performed.

6. The information processing device according to claim 1, wherein
the voting data is represented by a histogram of each of a plurality of pieces of identification information, and
the determiner determines whether to confirm collation based on at least one of a frequency of the histogram for each piece of identification information for identifying the collation result and a voting ratio for the each piece of identification information for identifying the collation result.

7. The information processing device according to claim 6, wherein
the determiner changes at least one of a threshold value for determining the frequency and a threshold value for determining the voting ratio according to the length of the voting target sequence.

8. The information processing device according to claim 6, wherein
the determiner changes at least one of a threshold value for determining the frequency and a threshold value for determining the voting ratio according to a type of the target.

9. The information processing device according to claim 1, wherein the one or more hardware processors are configured to further function as:
a detector configured to detect a tracking target region including a tracking target from the frame, and
the collation unit adds the identification information for identifying the collation result obtained by collating the tracking target in each of tracking target regions to an identification information sequence stored for each tracking target.

10. The information processing device according to claim 1, wherein the one or more hardware processors are configured to further function as:
a divider configured to divide the frame into a plurality of divided regions, and
the collation unit adds the identification information for identifying the collation result obtained by collating the target in each of the divided regions to an identification information sequence stored for each of the divided regions.

11. The information processing device according to claim 1, wherein the one or more hardware processors are configured to further function as:
a feedback unit configured to display feedback information including voting data of the identification information of top K voting results on a display device, where K is an integer equal to or greater than one, in a case where the voting data is not confirmed for a certain period of time.

12. The information processing device according to claim 1, wherein
the collation unit acquires the identification information for identifying the collation result in the frame of the target from a collation dictionary by collating the target based on a similarity between a feature amount of the target included in the frame and a feature amount of the target stored in the collation dictionary using the collation dictionary storing therein the identification information for identifying the target in the frame in association with the feature amount of the target in the collation dictionary.

13. The information processing device according to claim 1, wherein
the target includes at least one of a face, a person, an object, and a visual question answering (VQA) target.

14. An information processing method executed by an information processing device, the method comprising:
collating a target included in a frame for each frame included in a moving image, and adding identification information for identifying a collation result in the frame to an identification information sequence;
acquiring voting target sequences indicating identification information sequences to be voted from the identification information sequence in an order of newness of an addition time of the identification information;
obtaining voting data by voting on a collation result using identification information included in the voting target sequence;
determining whether to confirm the voting data;
deciding to extend a length of the voting target sequence in a case where the voting data is not confirmed; and
outputting a collation result based on the voting data in a case where the voting data is confirmed, wherein
the length of the voting target sequence is extended according to processing at the deciding, and
in a case where the length of the voting target sequence is extended, voting on the collation result is continued using identification information included in the extended voting target sequence.

15. A computer program product having a non-transitory computer readable medium including instructions stored thereon, wherein the instructions, when executed by a computer, cause the computer to function as:
a collation unit configured to collate a target included in a frame for each frame included in a moving image, and add identification information for identifying a collation result in the frame to an identification information sequence;
an acquisition unit configured to acquire voting target sequences indicating identification information sequences to be voted from the identification information sequence in an order of newness of an addition time of the identification information;
a voting unit configured to obtain voting data by voting on a collation result using identification information included in the voting target sequence; and
a determiner configured to determine whether to confirm the voting data, decide to extend a length of the voting target sequence in a case where the voting data is not confirmed, and output a collation result based on the voting data in a case where the voting data is confirmed, wherein
the acquisition unit extends a length of the voting target sequence according to a decision by the determiner, and
in a case where the length of the voting target sequence is extended, the voting unit continues voting on the collation result using identification information included in the extended voting target sequence.
